(19) United States
(12) Patent Application Publication
(10) Pub. No.: US 2026/0328884 A1
(43) Pub. Date: Oct. 22, 2026

(54) INFORMATION PROCESSING DEVICE AND INFORMATION PROCESSING METHOD

(71) Applicant: SONY SEMICONDUCTOR SOLUTIONS CORPORATION, KANAGAWA (JP)

(72) Inventors: TAKAYUKI HIRABAYASHI, KANAGAWA (JP); OSAMU KOZAKAI, KANAGAWA (JP)

(21) Appl. No.: 19/122,778

(22) PCT Filed: Oct. 16, 2023
(86) PCT No.: PCT/JP2023/037319

§ 371 Date: Apr. 21, 2025

(30) Foreign Application Priority Data
Oct. 28, 2022 (JP) 2022-173699

(51) Int. Cl. G01S 3/48; G01S 11/04

(52) U.S. Cl. CPC G01S 3/48; G01S 11/04

(57) ABSTRACT

An information processing device includes a correction processing unit configured to perform correction related to distance measurement information calculated on the basis of a propagation time of a radio wave from a transmission device to an antenna, on the basis of information regarding an arrival angle of a radio wave transmitted from the transmission device and received by the antenna.

### TECHNICAL FIELD

The present technology relates to an information processing device and an information processing method, and particularly relates to a technology related to distance measurement using a radio wave arrival angle.

### BACKGROUND ART

In an indoor positioning technology, it is difficult to receive a satellite radio wave, and thus, a method not using a satellite radio wave has been proposed. As an indoor positioning technology, there is a method of performing positioning using distance information about a distance to a predetermined device (Non-Patent Document 1 below).

### CITATION LIST

### Non-Patent Document

Non-Patent Document 1: Antonio R. Jiménez, Fernando Seco, IEEE Transactions on Instrumentation and Measurement (extension from 2016 IPIN Conference), April 2017, “Comparing Ubisense, Bespoon, and Decawave UWB location systems: indoor performance analysis” DOI: 10.1109/TIM.2017.2681398

### SUMMARY OF THE INVENTION

### Problems to be Solved by the Invention

Distance information about a distance to a device can be calculated using a propagation time of a radio wave. However, the propagation time of the radio wave includes a spatial propagation time which is a time during which the radio wave propagates in a space and an antenna propagation time which is a time during which a signal propagates in an antenna.

Therefore, it is conceivable to obtain correct distance information by setting the propagation time to include only the spatial propagation time.

However, since the antenna propagation time varies depending on an arrival angle of the radio wave, it is difficult to obtain correct distance information.

The present technology is intended to solve the problem described above, and an object thereof is to improve accuracy of distance information calculated using a propagation time of a radio wave.

### Solutions to Problems

An information processing device according to the present technology includes a correction processing unit configured to perform correction related to distance measurement information calculated on the basis of a propagation time of a radio wave from a transmission device to an antenna, on the basis of information regarding an arrival angle of a radio wave transmitted from the transmission device and received by the antenna.

The correction related to distance measurement information may be correction of the distance measurement information or correction of the propagation time to be used for calculation of the distance measurement information.

The antenna propagation time based on the information about the arrival angle is used to correct the propagation time or the distance measurement information.

An information processing method of the present technology includes: causing an arithmetic processing device to execute processing of performing correction related to distance measurement information calculated on the basis of a propagation time of a radio wave from a transmission device to an antenna, on the basis of information regarding an arrival angle of a radio wave transmitted from the transmission device and received by the antenna.

### BRIEF DESCRIPTION OF DRAWINGS

FIG. 1 is a view illustrating a state in which wireless communication is performed between a mobile terminal device and a communication device according to an embodiment of the present technology.

FIG. 2 is a block diagram illustrating an internal configuration example of an information processing device according to the embodiment.

FIG. 3 is a functional block diagram illustrating functions of a CPU of an information processing device according to a first embodiment.

FIG. 4 is an explanatory diagram of a method of calculating an arrival angle of a radio wave.

FIG. 5 is a graph illustrating a relationship between an arrival angle and a phase characteristic of an antenna.

FIG. 6 is a graph illustrating a relationship between an arrival angle and a distance measurement result.

FIG. 7 is an example of table data of an arrival angle and distance measurement error data.

FIG. 8 is a flowchart illustrating an example of processing executed by the information processing device according to the first embodiment.

FIG. 9 is a diagram for explaining an example of antennas having substantially the same mounting mode.

FIG. 10 is a diagram for explaining an example of antennas having different mounting modes.

FIG. 11 is a functional block diagram illustrating functions of a CPU of an information processing device according to a second embodiment.

FIG. 12 is a graph illustrating an example of a relationship between a calculated arrival angle and an arrival angle as a correct land.

FIG. 13 is a flowchart illustrating an example of processing executed by the information processing device according to the second embodiment.

FIG. 14 is a diagram illustrating an antenna arrangement example of a communication device according to a third embodiment.

FIG. 15 is a flowchart illustrating an example of processing executed by an information processing device according to the third embodiment.

FIG. 16 is a diagram illustrating a modification of an antenna arrangement.

FIG. 17 is a diagram illustrating another modification of an antenna arrangement.

FIG. 18 is a diagram illustrating an arrangement example of a dipole antenna.

FIG. 19 is a diagram illustrating another arrangement example of the dipole antenna.

FIG. 20 is a diagram illustrating an arrangement example of a monopole antenna.

FIG. 21 is a diagram illustrating another arrangement example of the monopole antenna.

FIG. 22 is a diagram illustrating still another arrangement example of the monopole antenna.

### MODE FOR CARRYING OUT THE INVENTION

Hereinafter, an embodiment will be described in the following order.
<1. First Embodiment>
<1-1. Configuration example of distance measuring system>
<1-2. Hardware Configuration of Information Processing Device>
<1-3. Functional Block of Information Processing Device>
<1-4. Processing flow>
<2. Second Embodiment>
<3. Third Embodiment>
<4. Modifications>
<5. Summary>
<6. Present Technology>

### 1. First Embodiment

### <1-1. Configuration Example of Distance Measuring System>

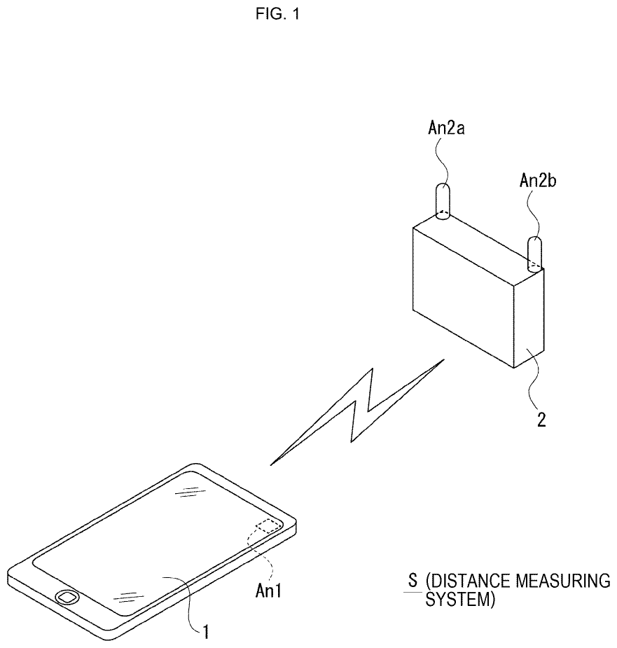

FIG. 1 illustrates a configuration example of a distance measuring system S according to a first embodiment of the present technology.

The distance measuring system S includes a mobile terminal device 1 and a communication device 2 capable of performing wireless communication with the mobile terminal device 1. Note that the distance measuring system S may include two or more communication devices 2 for one mobile terminal device 1.

The mobile terminal device 1 is a computer device which includes a microcomputer including a central processing unit (CPU), a read only memory (ROM), a random access memory (RAM), and the like. The mobile terminal device 1 is a device that can be carried by a user, such as a smartphone, a tablet terminal, or a remote controller, for example. In the following description, an example in which the mobile terminal device 1 is a smartphone will be used.

Near field communication can be performed between the mobile terminal device 1 and the communication device 2. In this example, wireless communication by an ultra wide band (UWB) is possible.

However, the wireless communication performed between the mobile terminal device 1 and the communication device 2 is not limited to the UWB, and may be public wireless communication such as a 4th generation mobile communication system (4G), a 5th generation mobile communication system (5G), or long term evolution (LTE), Bluetooth (registered trademark) low energy (BLE), a wireless local area network (LAN) such as Wi-Fi (registered trademark), or various systems such as ZegBee, sub GHz communication, millimeter wave communication, an ultra wide band (UWB), near field communication (NFC), or TransferJTE.

The distance measuring system S measures a distance between the mobile terminal device 1 and the communication device 2. An information processing device that measures the distance may be the mobile terminal device 1, the communication device 2, or a device different from each of these devices. In this example, an example will be described in which the communication device 2 is an information processing device that executes various types of processing for distance measurement.

Note that, in a case of referring to the information processing device that performs various types of processing for distance measurement without distinguishing the mobile terminal device 1, the communication device 2, or other devices, it is simply referred to as an “information processing device M”.

The information processing device M measures a distance between the mobile terminal device 1 and the communication device 2, that is, a distance between the communication device 2 and a user who carries the mobile terminal device 1.

The measurement (distance measurement) of the distance between the mobile terminal device 1 and the communication device 2 can be achieved, for example, by using a propagation time of a radio wave transmitted from the mobile terminal device 1.

The propagation time can be obtained from, for example, a difference time between a time at which the mobile terminal device 1 transmits a radio wave and a time at which the communication device 2 receives a radio wave.

However, the difference time between the transmission time and the reception time includes not only a spatial propagation time, which is a time during which the radio wave propagates in a space between the mobile terminal device 1 and the communication device 2, but also a time (antenna propagation time) during which a signal propagates in an antenna An1 of the mobile terminal device 1 and a time during which the signal propagates in an antenna An2 of the communication device 2.

Therefore, by subtracting the antenna propagation time from the propagation time, the propagation time can be made include only the spatial propagation time. As a result, it becomes possible to accurately calculate the distance between the mobile terminal device 1 and the communication device 2.

The antenna propagation time can be calculated by obtaining a phase change of the signal propagating in the antenna.

However, the antenna propagation time varies depending on an incident angle of a radio wave transmitted from the antenna An1 of the mobile terminal device 1 with respect to the antenna An2 of the communication device 2, that is, an arrival angle D of the radio wave.

Therefore, in the distance measuring system S of the present technology, the propagation time including only the spatial propagation time is calculated by calculating the arrival angle D of the radio wave in the communication device 2, which improves the distance measuring accuracy for the distance between the mobile terminal device 1 and the communication device 2.

There are several possible methods of calculating the arrival angle D of the radio wave. In the present embodiment, the communication device 2 includes a plurality of antennas An2a and An2b, and calculates the arrival angle D of a radio wave transmitted from the mobile terminal device 1 on the basis of a difference between reception timings of radio waves of the antennas An2a and An2b.

Note that the arrival angle D may also be calculated by specifying positions of the mobile terminal device 1 and the communication device 2 by using, for example, a global navigation satellite system (GNSS) such as a global positioning system (GPS). Furthermore, a geomagnetic sensor, a gyro sensor, a radar, or the like may be used.

In the following description, when the antennas An2a, An2b, and the like are not distinguished, the antennas An2a, An2b, and the like may be referred to as antennas An2.

Note that an antenna An in FIG. 1 and each of figures to be described later is schematically illustrated. As the antenna An of each of the mobile terminal device 1 and the communication device 2, various antennas such as a monopole antenna, a dipole antenna, a patch antenna, and an inverted-F antenna can be adopted.

### <1-2. Hardware Configuration of Information Processing Device>

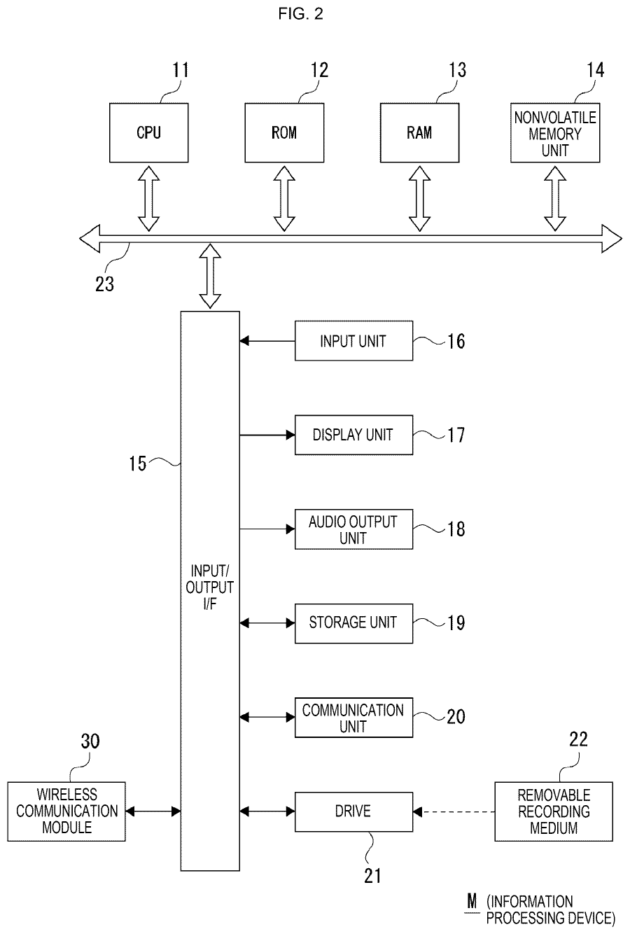

An example of a hardware configuration of the information processing device M (the communication device 2 in the present example) or the mobile terminal device 1 is illustrated in FIG. 2. In the following description, each unit of the information processing device M as the communication device 2 will be described, but the mobile terminal device 1 also has a similar configuration.

As illustrated, the information processing device M (communication device 2) includes a CPU 11. The CPU 11 executes various types of processing in accordance with a program stored in a ROM 12 or a nonvolatile memory unit 14 such as an electrically erasable programmable read-only memory (EEP-ROM) or the like, or a program loaded from a storage unit 19 to a RAM 13. Furthermore, the RAM 13 appropriately stores data and the like necessary for the CPU 11 to execute various types of processing.

The program here can include an application program for calculating a distance to the mobile terminal device 1 and an application program for implementing various functions using distance measurement information, such as a navigation function, for example.

The CPU 11, the ROM 12, the RAM 13, and the nonvolatile memory unit 14 are connected to one another via a bus 23. Furthermore, an input/output interface (I/F) 15 is also connected to the bus 23.

An input unit 16 including an operation element or an operation device is connected to the input/output interface 15. For example, as the input unit 16, various types of operation elements and operation devices such as a keyboard, a mouse, a key, a dial, a touch panel, a touch pad, and a remote controller are assumed.

An operation is detected by the input unit 16, and a signal corresponding to the detected operation is interpreted by the CPU 11.

Furthermore, a display unit 17 including a liquid crystal display (LCD), an organic electro-luminescence (EL) panel, or the like, and an audio output unit 18 including a speaker or the like are integrally or separately connected to the input/output interface 15.

The display unit 17 is used for displaying various types of information, and includes, for example, a display device provided in a housing of the information processing device M, a separate display device connected to the information processing device M, or the like.

The display unit 17 displays an image for various types of image processing, a moving image to be processed, or the like, on a display screen on the basis of an instruction from the CPU 11. Furthermore, the display unit 17 displays various operation menus, icons, messages, and the like, that is, performs display as a graphical user interface (GUI), on the basis of an instruction from the CPU 11.

In some cases, the storage unit 19 including a hard disk drive (HDD), a solid-state memory, or the like, and a communication unit 20 including a modem or the like are connected to the input/output interface 15.

The communication unit 20 communicates with an external device via a network line such as the Internet.

Furthermore, a drive 21 is also connected to the input/output interface 15 as necessary, and a removable recording medium 22, such as a magnetic disk, an optical disk, a magneto-optical disk, or a semiconductor memory, is mounted appropriately.

The drive 21 can read a data file or the like such as a program used for each process from the removable recording medium 22. The read data file is stored in the storage unit 19, and an image or audio included in the data file is output by the display unit 17 or the audio output unit 18. Furthermore, a computer program or the like read from the removable recording medium 22 is installed in the storage unit 19 as necessary.

Furthermore, a wireless communication module 30 is connected to the input/output interface 15.

The wireless communication module 30 is a communication module for performing near field communication with an external device. Specifically, the wireless communication module 30 in the mobile terminal device 1 is configured to be able to perform wireless communication using the UWB between with the communication device 2. Similarly, the wireless communication module 30 in the communication device 2 is configured to be able to perform wireless communication using the UWB between with the mobile terminal device 1.

Note that, in a case where the information processing device M is provided separately from the mobile terminal device 1 and the communication device 2, it is sufficient that the mobile terminal device 1 and the communication device 2 each include the wireless communication module 30, and the information processing device M does not need to include the wireless communication module 30.

### <1-3. Functional Block of Information Processing Device>

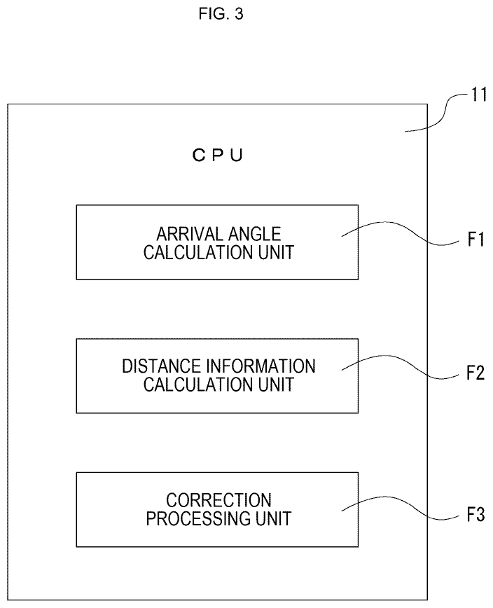

The communication device 2 as the information processing device M has a function for measuring a distance to the mobile terminal device 1 by the CPU 11 executing a program. An example is illustrated in FIG. 3.

The CPU 11 of the communication device 2 functions as an arrival angle calculation unit F1, a distance information calculation unit F2, and a correction processing unit F3.

The arrival angle calculation unit F1 calculates the arrival angle D when the communication device 2 receives a radio wave transmitted from the mobile terminal device 1.

The arrival angle D may be calculated using a GPS or the like, but in the present example, the arrival angle D is calculated using the two antennas An2a and An2b included in the communication device 2.

The arrival angle D is obtained by performing wireless communication at a specific frequency between the mobile terminal device 1 and the communication device 2, and measuring a phase p of a signal propagation path.

Here, the phase p will be described. The mobile terminal device 1 transmits a radio wave subjected to IQ modulation. The communication device 2 receives the radio wave subjected to IQ modulation, and extracts an I channel signal and a Q channel signal. The phase p is obtained by the following [Expression 1] using an amplitude I of an I channel signal and an amplitude Q of a Q channel signal.

p=arctan (Q/I) [Expression 1]

The phase p is measured in both a combination of the antenna An1 of the mobile terminal device 1 and the antenna An2a of the communication device 2 and a combination of the antenna An1 and the antenna An2b. Here, the phase p in the combination of the antenna An1 and the antenna An2a is a phase p1, and the phase p in the combination of the antenna An1 and the antenna An2b is a phase p2.

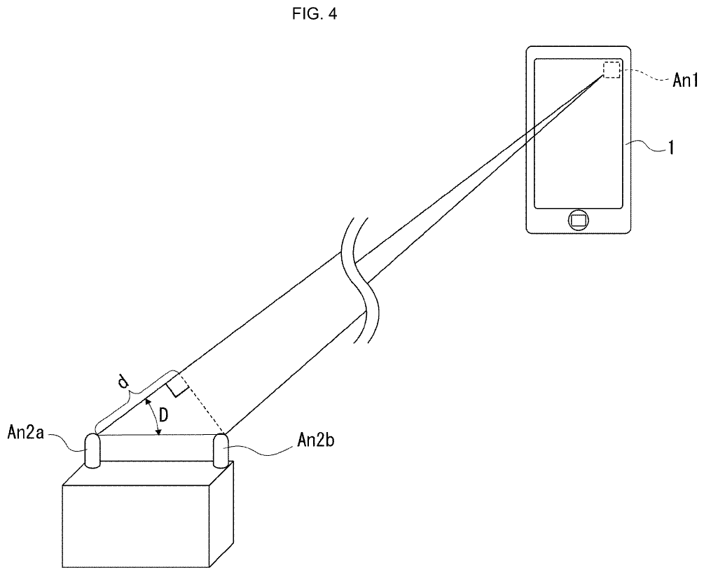

A length of the signal propagation path is different for every combination of the antennas An, and a difference d of the signal propagation path increases as the arrival angle D becomes closer to 0 degrees. Furthermore, since there is the difference d in the signal propagation path, the phases p1 and p2 are different (see FIG. 4).

That is, the arrival angle D can be obtained by calculating the difference d of the signal propagation path by using the difference between the phases p1 and p2.

Since the method of calculating the arrival angle D is standardized by the standardization organization, further details are omitted.

Note that, when a case where a radio wave is transmitted from the mobile terminal device 1 to the communication device 2 is a forward path and a case where a radio wave is transmitted in the opposite direction is a backward path, a phase po which is the phase p in the forward path and a phase pr which is the phase p in the backward path may be calculated, and an average value of the phase po and the phase pr may be set as the phase p of the signal propagation path.

Note that the phase p used to calculate the arrival angle D also includes a phase that changes depending on a time during which the signal propagates inside the antenna An1 and the antenna An2, but the phase that changes depending on the antenna propagation time is canceled by taking the difference between the phase p1 and the phase p2, so that the difference d can be calculated without any problem.

The distance information calculation unit F2 calculates a distance between the mobile terminal device 1 and the communication device 2. At this time, in a case where the antenna propagation time is negligibly small, it is possible to calculate substantially accurate distance measurement information by using the phase p1 or the phase p2 described above and a light speed.

Here, the case where the antenna propagation time is negligibly small is, for example, a case where the arrival angle D (see FIG. 4) is around 90 deg.

However, in a case where the arrival angle D is away from 90 deg, the antenna propagation time cannot be ignored.

The correction processing unit F3 performs processing for correcting a distance measurement error based on the antenna propagation time. Specifically, the distance measurement information calculated by the distance information calculation unit F2 is corrected.

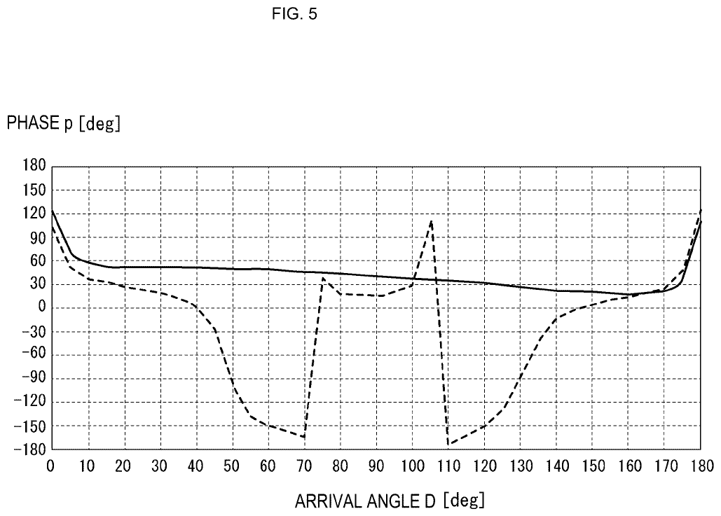

First, an example of a relationship between the arrival angle D and the phase p is illustrated in FIG. 5. Note that this is an example of a case where the antenna An1 and the antenna An2 are dipole antennas. Furthermore, a solid line in FIG. 5 is a graph when a dipole antenna having a length of 0.5 times a wavelength used for wireless radio waves is used, and a broken line is a graph when a dipole antenna having a length of 3 times a wavelength used for wireless radio waves is used.

In the following description, a broken line graph will be focused.

In FIG. 5, a horizontal axis represents the arrival angle D, and a vertical axis represents the above-described phase p (a phase of the entire propagation path including a space and an inside of the antenna).

As illustrated, when the arrival angle D is around 90 deg, a phase change in the antenna An is about 20 deg. Whereas, when the arrival angle D is around 110 deg, a phase change in the antenna An is about −180 deg. That is, the phases p are completely different between the arrival angles D of 90 deg and 110 deg.

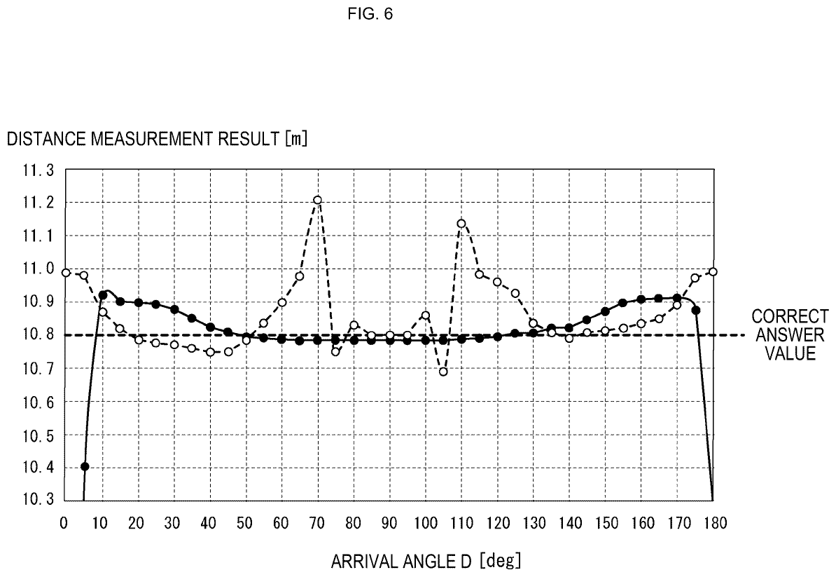

A distance measurement error based on the antenna propagation time is illustrated in FIG. 6. In FIG. 6, a horizontal axis represents the arrival angle D, and a vertical axis represents a distance measurement result. This measurement result is obtained by performing distance measurement while changing only a direction of the communication device 2 without changing positions of the mobile terminal device 1 and the communication device 2.

A solid line in FIG. 6 is a graph when a dipole antenna having a length of 0.5 times a wavelength used for wireless radio waves is used, and a broken line is a graph when a dipole antenna having a length of 3 times a wavelength used for wireless radio waves is used.

Note that, in the example illustrated in FIG. 6, the distance between the mobile terminal device 1 and the communication device 2 is 10.8 m. Therefore, it is indicated that the distance measurement error is larger as the distance measurement result is farther from 10.8 m.

The correction processing unit F3 corrects the distance measurement information data calculated by the distance information calculation unit F2 on the basis of the measurement data illustrated in FIG. 6. Specifically, for example, in a case where the arrival angle D is 70 deg, the distance measurement result is about 11.2 m, which is calculated to be about 40 cm larger than the correct answer value of 10.8 m.

Therefore, in a case where the arrival angle D is 70 deg, the correction processing unit F3 subtracts 40 cm from the distance measurement information calculated by the distance information calculation unit F2 to obtain corrected distance measurement information.

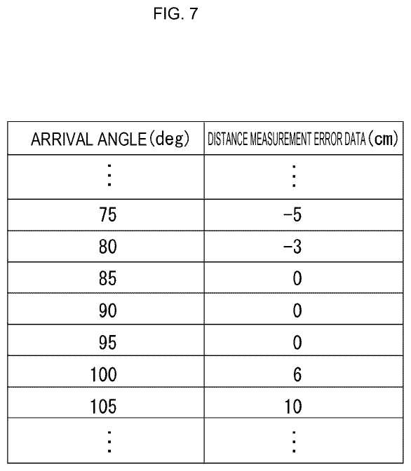

Note that the graph data illustrated in FIG. 6 may be stored in the storage unit 19 of the communication device 2 as information to be used for the correction processing performed by the correction processing unit F3, or distance measurement error data (see FIG. 7) of every arrival angle D may be stored in the storage unit 19 of the communication device 2 as table data.

In the table data illustrated in FIG. 7, the arrival angle D and the distance measurement error data for every 5 deg are associated with each other.

Note that since the distance measurement error data is data of a distance measurement error caused according to a propagation characteristic of the antenna An, the distance measurement error data can be regarded as data of the propagation characteristic of the antenna An.

Furthermore, FIG. 7 is a table of distance measurement error data for the antenna An2a, for example. Since the communication device 2 includes the plurality of antennas An2a and An2b, table data for the distance measurement error data of every antenna An2 may be stored in the storage unit 19.

By storing the table data for each of the plurality of antennas An2 included in the communication device 2 into the storage unit 19 of the communication device 2, it is possible to perform distance measurement using any antenna An2.

Note that the information to be used for correction processing performed by the correction processing unit F3 may be graph data illustrated in FIG. 5 or table data based on the graph data of FIG. 5, in addition to the graph data illustrated in FIG. 6 and the table data illustrated in FIG. 7.

That is, the correction processing unit F3 may use table data in which graphs of the arrival angle D and the phase p are tabulated in the correction processing.

### <1-4. Processing Flow>

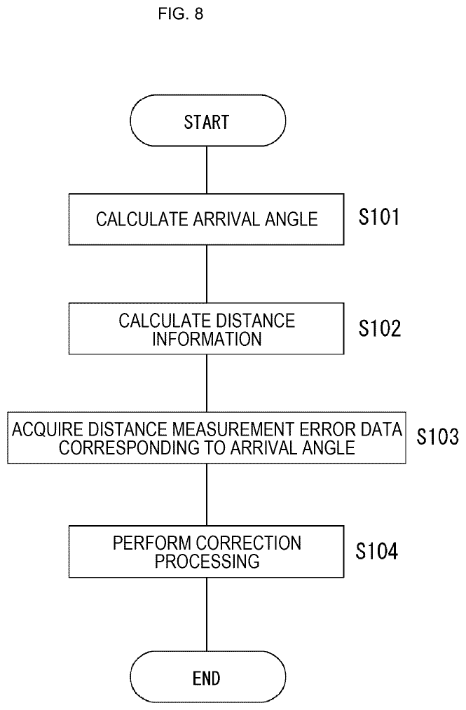

FIG. 8 illustrates a flow of processing executed by the communication device 2 to calculate a distance between the mobile terminal device 1 and the communication device 2.

First, in the step of performing the processing illustrated in FIG. 8, the mobile terminal device 1 and the communication device 2 are brought into a state in which the devices have completed various types of processing for performing distance measurement through wireless communication.

In step S101, the CPU 11 of the communication device 2 calculates the arrival angle D on the basis of a radio wave received from the mobile terminal device 1.

Subsequently, in step S102, the CPU 11 of the communication device 2 calculates distance information about a distance to the mobile terminal device 1, on the basis of the radio wave received by the antenna An2.

Next, in step S103, the CPU 11 of the communication device 2 acquires, from the storage unit 19, distance measurement error data corresponding to the arrival angle D.

In step S104, the CPU 11 of the communication device 2 corrects the distance information by using the distance measurement error data. As a result, it is possible to acquire highly accurate distance measurement information in consideration of the propagation characteristic of the antenna An which changes according to the arrival angle D.

Note that, in the above-described correction processing, the method of correcting the distance measurement information calculated once has been described, but highly accurate distance measurement information may be obtained by performing correction with respect to a phase change.

### 2. Second Embodiment

The corrected distance measurement information calculated in the first embodiment is highly accurate in a case where mounting modes of the two antennas An2a and An2b included in the communication device 2 are substantially the same and the propagation characteristics (phase characteristics) of the antennas An2a and An2b match.

Note that, even if the mounting modes of the antennas An2a and An2b are different, in a case where the phase characteristics of the antennas An2a and An2b are substantially the same, it is possible to obtain highly accurate distance measurement information by using the technique described in the first embodiment.

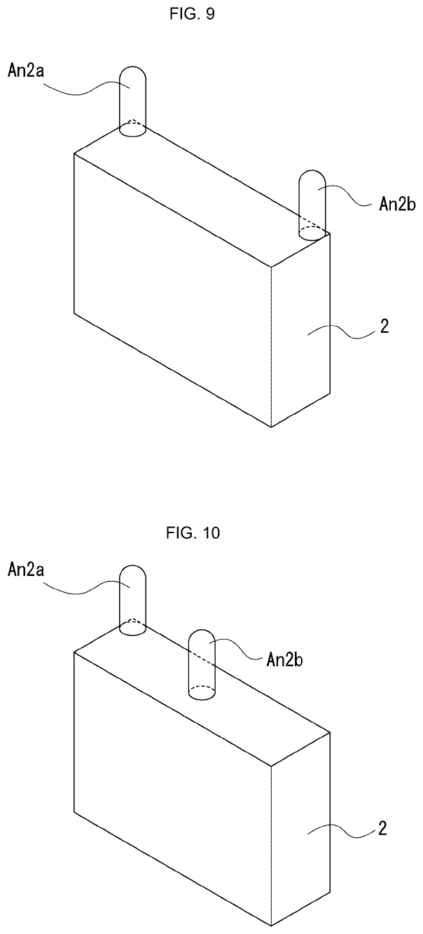

The mounting modes of the antennas An2a and An2b being substantially the same refer to, for example, a state as illustrated in FIG. 9. The antennas An2a and An2b illustrated in FIG. 9 are of substantially the same in type, length (size), and distance and position from the closest corner of a housing of the communication device 2.

Whereas, in a case where the phase characteristics of the antennas An2a and An2b are different, even if a difference between the phase p1 and the phase p2 of the antennas An2a and An2b is taken, a phase change due to the antenna propagation time cannot be canceled and an error occurs in the difference d of the signal propagation path illustrated in FIG. 4.

If a large error occurs in the difference d, the arrival angle D becomes inaccurate, the table data cannot be correctly referred to, and there is a possibility that a large error is included in the corrected distance measurement result.

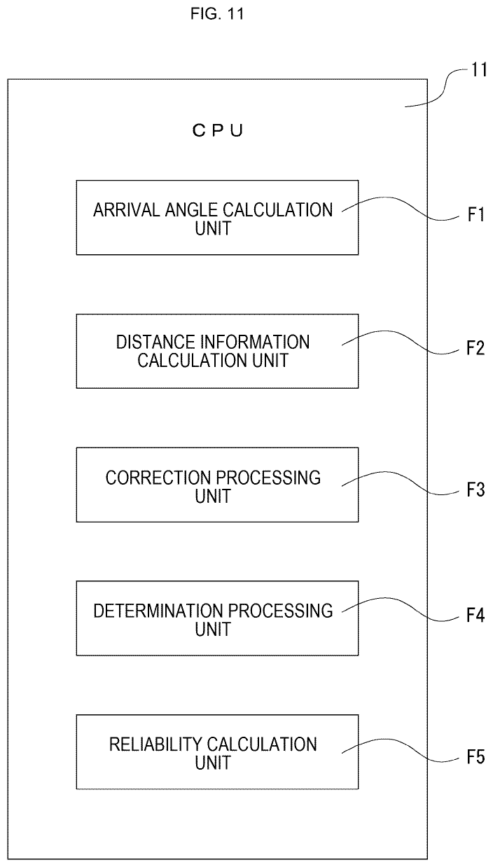

Note that the case where the mounting modes of the antennas An2a and An2b are different is, for example, a state as illustrated in FIG. 10. While the antenna An2a illustrated in FIG. 10 is mounted near a corner of the housing of the communication device 2, the antenna An2b is mounted near a center of an upper surface of the housing.

In such a case, even if the antennas An2a and An2b are of the same type and the same shape, the phase characteristics of the antennas An2a and An2b are deviated.

A distance measuring system SA according to a second embodiment is configured to be able to appropriately correct distance measurement information even when the phase characteristics of the antennas An2a and An2b are different.

In the following description, portions different from those of the first embodiment will be mainly described.

FIG. 11 is a functional block diagram of a communication device 2. In the communication device 2, by a CPU 11 executing a program, the CPU 11 has functions as an arrival angle calculation unit F1, a distance information calculation unit F2, a correction processing unit F3, a determination processing unit F4, and a reliability calculation unit F5.

As illustrated in FIG. 4, the arrival angle calculation unit F1 calculates the arrival angle D by calculating the difference d of signal propagation path. However, in the present embodiment, since phase characteristics of the antennas An2a and An2b are different, a difference d includes a non-negligible error.

The determination processing unit F4 determines whether or not to correct the error of the arrival angle D based on the difference d.

Whether or not to correct the arrival angle D is determined by determining whether or not the phase characteristics of the antennas An2a and An2b are similar to each other, for example.

Specifically, a correlation coefficient c of phase characteristic graphs of the antennas An2a and An2b is calculated, and the determination processing unit F4 determines not to correct the arrival angle D in a case where the correlation coefficient c is equal to or greater than a threshold value. Whereas, in a case where the correlation coefficient c is less than the threshold value, the determination processing unit F4 determines to correct the arrival angle D.

The correlation coefficient c can be calculated on the basis of a standard deviation of the phase characteristics of the antenna An2a, a standard deviation of the phase characteristics of the antenna An2b, and a covariance of the phase characteristics of the antennas An2a and An2b.

The correlation coefficient c may be calculated at every distance measurement, but values calculated for the antennas An2a and An2b may be stored in the storage unit 19 of the communication device 2. The determination processing unit F4 acquires the correlation coefficient c for the phase characteristics of the antennas An2a and An2b from the storage unit 19, and compares the correlation coefficient c with a threshold value to determine whether or not to correct the arrival angle D.

The threshold value as a comparison target of the correlation coefficient c may be uniformly the same value, or may be set for every application that handles distance measurement information. For example, the threshold value is set high in a case where the distance measurement information is used for an application that requires highly accurate distance measurement information, and the threshold value is set low in a case where the distance measurement information is used for an application in which the distance measurement information does not need to be highly accurate but needs to be calculated with high frequency.

Note that the determination processing unit F4 may determine whether or not to correct the arrival angle D in accordance with still another condition, in a case where the correlation coefficient c is less than the threshold value. For example, in a case where the distance measurement information needs to be calculated at a high frequency, and a processing time for correcting the arrival angle D is insufficient, it may be determined not to correct the arrival angle D.

Furthermore, the determination processing unit F4 may determine whether or not to correct the arrival angle D on the basis of information indicating whether or not mounting modes such as antenna types, shapes, sizes, and positions of the antennas An2a and An2b are substantially the same without calculating the correlation coefficient c. This information may be stored at the time of manufacturing the communication device 2.

Specifically, if the mounting modes of the antennas An2a and An2b are substantially the same, flag information or the like indicating that the mounting modes are the same is stored in the storage unit 19.

The correction processing unit F3 corrects the arrival angle D on the basis of a determination result of the determination processing unit F4.

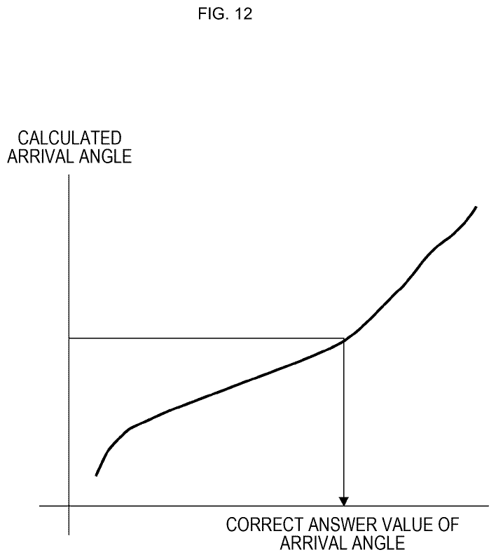

The arrival angle D is corrected, for example, by referring to table data. Specifically, an example of a relationship between the calculated arrival angle D and the correct answer value of the arrival angle D is illustrated in FIG. 12.

In a graph of FIG. 12, a horizontal axis represents a correct answer value of the arrival angle D, and a vertical axis represents the calculated arrival angle D. The storage unit 19 of the communication device 2 stores table data generated on the basis of the graph illustrated in FIG. 12. The table data is, for example, data in increments of 5 deg, and values in between are calculated by linear interpolation.

The distance information calculation unit F2 calculates a distance between the mobile terminal device 1 and the communication device 2 on the basis of the corrected arrival angle D. The distance calculated here can include an error caused by the antenna propagation time similarly to the first embodiment.

The correction processing unit F3 corrects the distance measurement information calculated by the distance information calculation unit F2. The phase characteristic of the antenna An2 is used to correct the distance measurement information.

Similarly to the first embodiment, the phase characteristic of the antenna An2 is stored in the storage unit 19 of the communication device 2 as table data or the like.

The reliability calculation unit F5 calculates a reliability R of the distance measurement information. The reliability R is, for example, three stages of “high”, “medium”, and “low”.

For example, the reliability calculation unit F5 determines that the reliability R is “high” in a case where the correlation coefficient c is equal to or greater than a threshold value and the distance measurement information is calculated without correcting the arrival angle D, determines that the reliability R is “medium” in a case where the correlation coefficient c is less than the threshold value and the distance measurement information is calculated after correcting the arrival angle D, and determines that the reliability R is “low” in a case where the correlation coefficient c is less than the threshold value but the distance measurement information is calculated without correcting the arrival angle D.

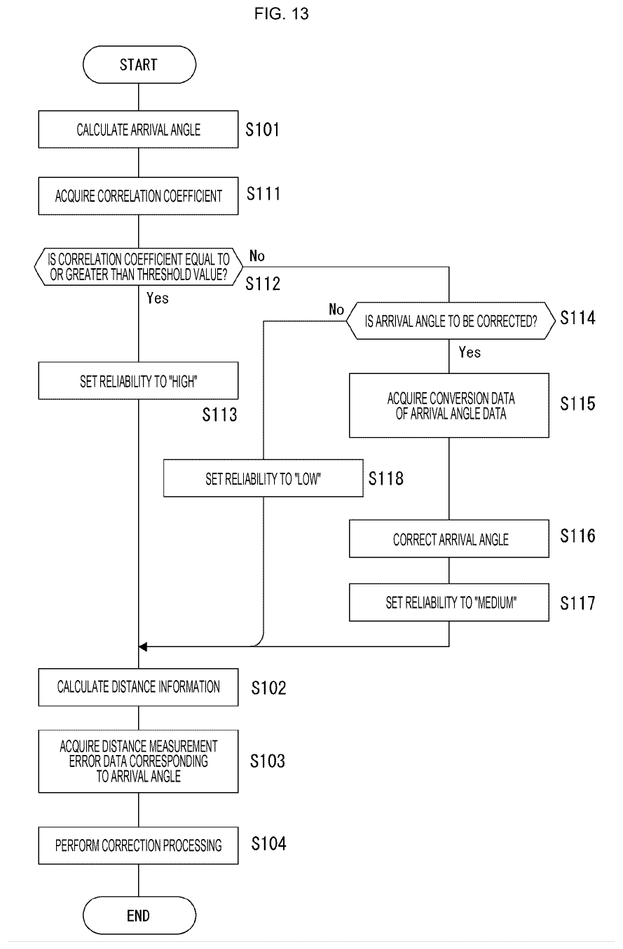

FIG. 13 illustrates a flow of processing executed by the CPU 11 of the communication device 2 in the second embodiment. Note that processing similar to that in FIG. 8 will be denoted by the same step number, and description thereof will be omitted as appropriate.

In step S101, the CPU 11 of the communication device 2 calculates the arrival angle D on the basis of a radio wave received from the mobile terminal device 1.

In step S111, the CPU 11 of the communication device 2 acquires, from the storage unit 19, the correlation coefficient c for the antennas An2a and An2b used for calculating the arrival angle D.

In step S112, the CPU 11 of the communication device 2 determines whether the correlation coefficient c is equal to or greater than a threshold value.

When the CPU 11 of the communication device 2 determines that the correlation coefficient c is equal to or greater than the threshold value, the CPU 11 sets the reliability R of the distance measurement information to “high” in step S113, and calculates distance information in subsequent step S102.

Moreover, the CPU 11 of the communication device 2 corrects the distance information by using distance measurement error data by performing the processing of steps S103 and S104.

Whereas, when the CPU 11 of the communication device 2 determines in step S112 that the correlation coefficient c is less than the threshold value, the CPU 11 determines in step S114 whether or not to correct the arrival angle D. In this processing, the determination may be made on the basis of an application using the distance measurement information as described above, or may be made on the basis of setting performed by a user. For example, in a case where the user selects setting using highly accurate distance information, it may be determined in step S114 to correct the arrival angle D.

When the CPU 11 of the communication device 2 determines to correct the arrival angle D, the CPU 11 acquires table data (similar to the graph of FIG. 12) for converting the arrival angle D in step S115, and corrects the arrival angle D in step S116.

Furthermore, the CPU 11 of the communication device 2 sets the reliability R of the distance measurement information to “medium” in step S117, and then the process proceeds to step S102.

Whereas, when the CPU 11 of the communication device 2 determines in step S114 not to correct the arrival angle D, the CPU 11 sets the reliability R of the distance measurement information to “low” in step S118, and the process proceeds to step S102.

Note that the reliability R set in steps S113, S117, and S118 may be presented, for example, when the distance measurement information is presented to the user.

Note that, in a case of determining whether or not to correct the arrival angle D in accordance with whether or not the mounting modes of the antennas An2a and An2b are substantially the same, the CPU 11 of the communication device 2 acquires information (flag information or the like) indicating the mounting modes in step S111, and determines whether or not the mounting modes of the antennas An2a and An2b are the same in step S112. Then, it suffices that the process proceeds to step S113 when it is determined that the mounting modes are the same, and the process proceeds to step S114 when it is determined that the mounting modes are not the same.

### 3. Third Embodiment

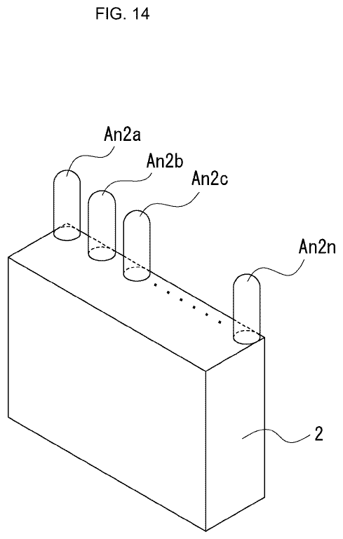

In a third embodiment, as illustrated in FIG. 14, a communication device 2 includes three or more antennas An2a, An2b, An2c, . . . .

In the present embodiment, the communication device 2 sequentially selects two antennas An2 from the plurality of antennas An2, to obtain highly accurate distance measurement information.

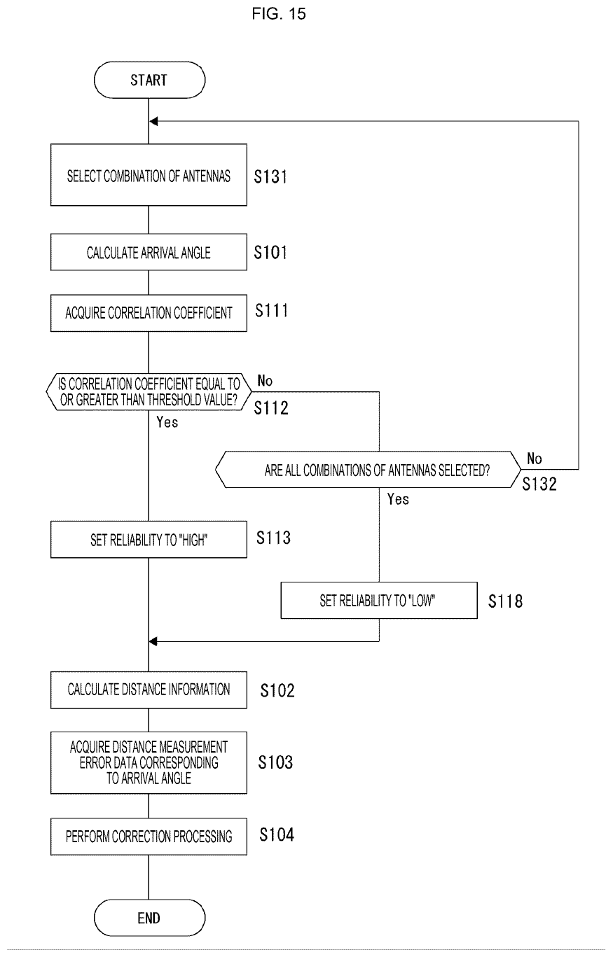

Specifically, a flow of processing executed by a CPU 11 of the communication device 2 is illustrated in FIG. 15. Note that processing similar to those in FIGS. 8 and 13 is denoted by the same step numbers, and description thereof is omitted as appropriate.

First, in step S131, the CPU 11 of the communication device 2 selects two antennas An2.

Subsequently, the CPU 11 of the communication device 2 calculates an arrival angle D on the basis of a radio wave received from the mobile terminal device 1 in step S101, acquires, from a storage unit 19, a correlation coefficient c for the two antennas An2 used to calculate the arrival angle D in step S111, and determines in step S112 whether the correlation coefficient c is equal to or greater than a threshold value.

When the CPU 11 of the communication device 2 determines that the correlation coefficient c is equal to or greater than the threshold value, the CPU 11 sets the reliability R of the distance measurement information to “high” in step S113, and performs processing of subsequent steps S102, S103, and S104 to calculate distance measurement information and correct distance information by using distance measurement error data.

Whereas, when the CPU 11 of the communication device 2 determines in step S112 that the correlation coefficient c is less than the threshold value, the CPU 11 determines in step S132 whether or not the processing has been executed for all the combinations of the antennas An2. In a case where there is a combination of the antennas An2 for which the arrival angle D has not been calculated in step S101, the CPU 11 of the communication device 2 returns to step S131 and selects a new combination of the antennas An2.

Whereas, when the CPU 11 of the communication device 2 determines that the arrival angle D has been calculated in step S101 for all the combinations of the antennas An2, the CPU 11 of the communication device 2 sets the reliability R of the distance measurement information to “low” in step S118, and the process proceeds to step S102.

Note that the processing of calculating the distance measurement information in step S102 may be executed for all the combinations of the antennas An2. Then, the distance measurement information set as a correction target in steps S103 and S104 may be the distance measurement information calculated in step S101 when the combination of the antennas An2 having the highest correlation coefficient c is selected.

Furthermore, in the example of FIG. 15, the arrival angle D in step S101 is calculated for all the combinations of the antennas An2. However, in a case where the storage unit 19 stores the correlation coefficient c of the phase characteristic graph of every combination of the antennas An2, the combination of the antennas An2 having the highest correlation coefficient c may be selected to calculate the arrival angle D in step S101.

That is, the processing in steps S101, S111, and S112 may be performed after the combination of the antennas An2 having the highest correlation coefficient c is selected in step S131, and each processing in steps S102 to S104 may be performed after any processing in step S113 or step S118 is performed according to the determination result in step S11.

As a result, the number of processing steps can be reduced, and a processing load can be reduced and a processing time can be shortened.

### 4. Modifications

An example of mounting modes of a plurality of antennas An2 will be described with reference to the accompanying drawings.

The communication device 2 illustrated in FIG. 14 is an example in which a plurality of antennas An2 are arranged in series, that is, a plurality of antennas An2 constitutes a linear array.

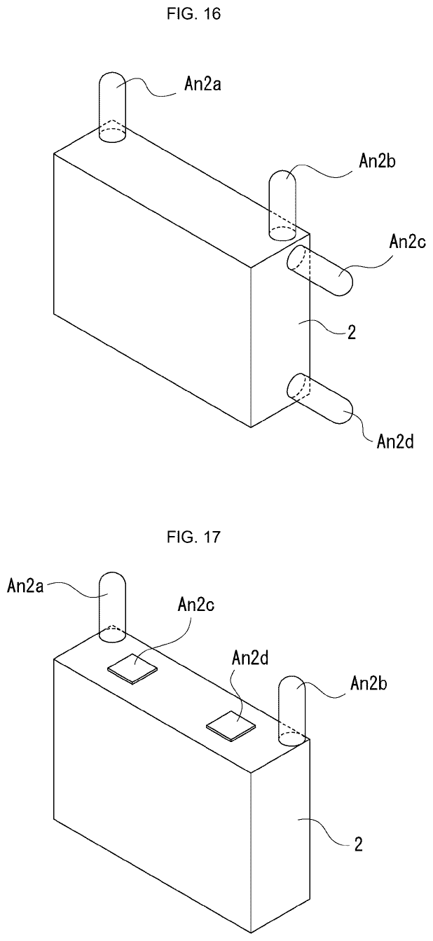

In a plurality of antennas An2 of the communication device 2 illustrated in FIG. 16, some antennas An2 and other antennas An2 are arranged to be orthogonal to each other. Specifically, in the example of FIG. 16, a first antenna pair (or a first antenna array) including the antennas An2a and An2b and a second antenna pair (or a second antenna array) including the antennas An2c and An2d are orthogonal to each other.

As a result, the arrival angle D and the distance measurement information can be calculated using an antenna pair having a smaller arrival angle D among the first antenna pair and the second antenna pair, so that the distance measurement accuracy can be improved.

The communication device 2 illustrated in FIG. 17 includes, for example, antennas An2a and An2b that are monopole antennas and antennas An2c and An2d that are patch antennas.

As a result, since the arrival angle D and the distance measurement information can be calculated using the antenna An2 having good reception sensitivity, the distance measurement accuracy can be improved.

Note that the distance measurement accuracy may be further improved by arranging the antennas An2a and An2b that are monopole antennas in FIG. 17 on an upper surface of the housing of the communication device 2 and arranging the antennas An2c and An2d that are patch antennas on a side surface of the housing of the communication device 2.

Furthermore, a relationship between an arrangement direction of the antennas An2 and the detectable arrival angle D will be described.

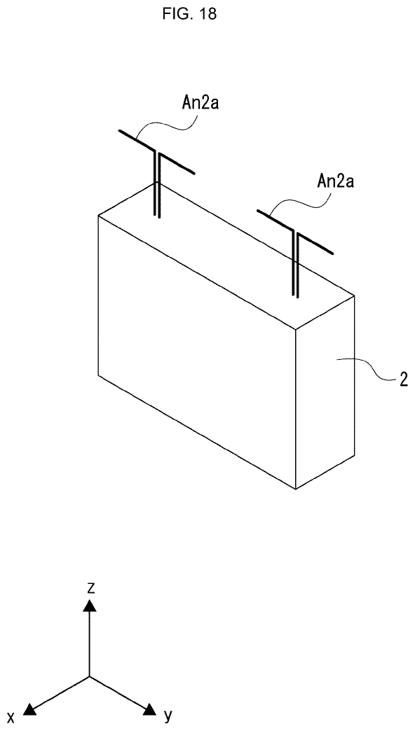

FIG. 18 illustrates an example in which the antennas An2a and An2b that are dipole antennas are arranged along an extending direction of a distal end of an antenna element.

That is, the antennas An2 each have a distal end portion facing a y-axis direction illustrated in the figure, and are arranged to be separated from each other in the y-axis direction.

In such antennas An2a and An2b, the arrival angle D in an xy plane and the arrival angle D in a yz plane can be suitably detected.

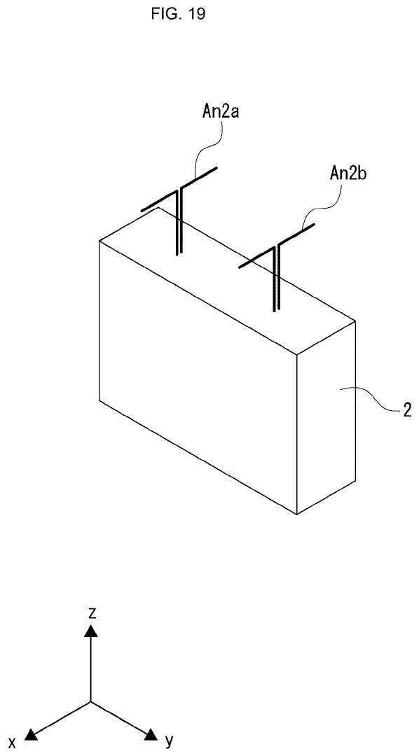

FIG. 19 illustrates an example in which the antennas An2a and An2b that are dipole antennas are arranged perpendicularly to the extending direction of the distal end of the antenna element.

That is, the antennas An2 each have a distal end portion facing an x-axis direction illustrated in the figure, and are arranged to be separated from each other in the y-axis direction.

In such antennas An2a and An2b, the arrival angle D in the xy plane and the arrival angle D in the yz plane can be suitably detected.

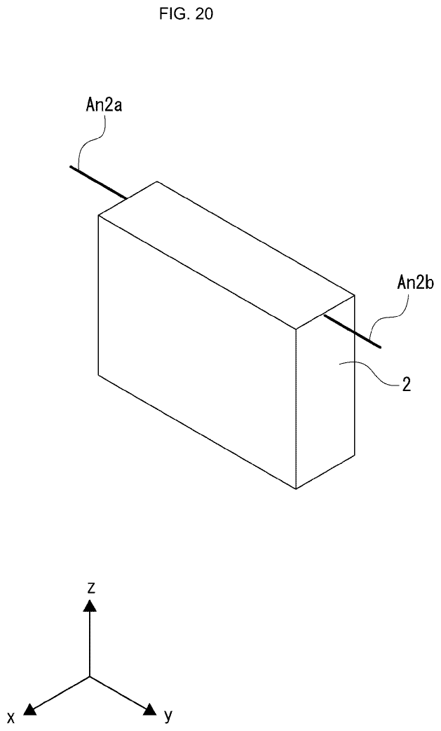

FIG. 20 illustrates an example in which the antennas An2a and An2b that are monopole antennas and in which the extending direction of the antenna element is the y-axis direction are arranged in opposite directions, while being separated from each other in the y-axis direction. Note that a ground conductor is not illustrated.

In such antennas An2a and An2b, the arrival angle D in the xy plane and the arrival angle D in the yz plane can be suitably detected.

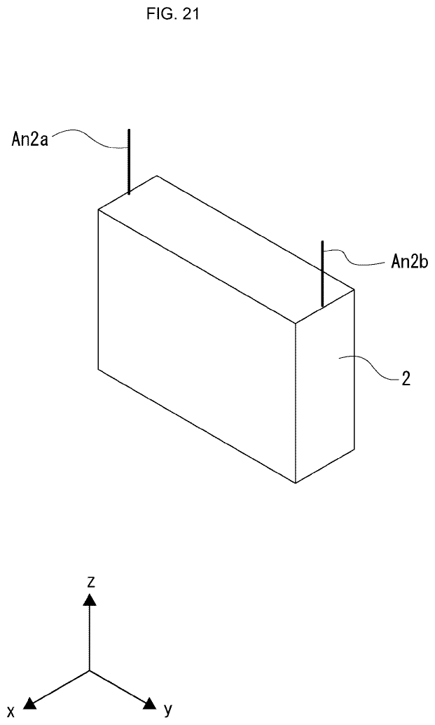

FIG. 21 illustrates an example in which the antennas An2a and An2b that are monopole antennas and in which an extending direction of the distal end of the antenna element is a z-axis direction are arranged to be separated from each other in the y-axis direction. Note that a ground conductor is not illustrated.

In such antennas An2a and An2b, the arrival angle D in the xy plane and the arrival angle D in the yz plane can be suitably detected.

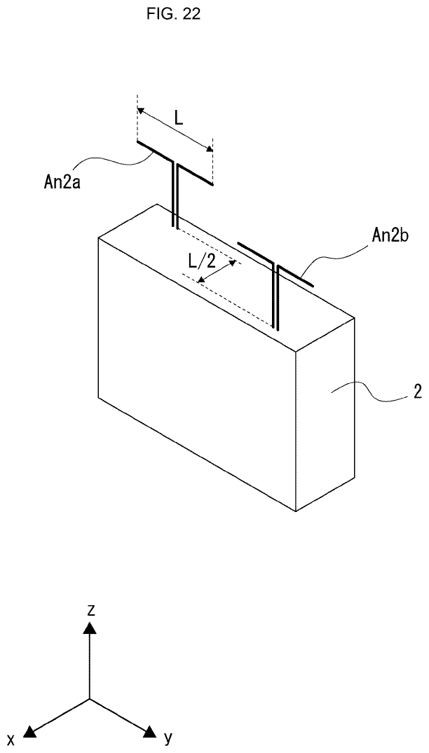

FIG. 22 illustrates an example in which the antennas An2a and An2b that are dipole antennas and in which an extending direction of the distal end of the antenna element is the y-axis direction are arranged to be separated from each other in the x-axis direction and the y-axis direction.

Furthermore, a distance between the antennas An2a and An2b in the x-axis direction is half a length L of antenna An2a in the y-axis direction.

Even in such antennas An2a and An2b, the arrival angle D in the xy plane and the arrival angle D in the yz plane can be detected.

The mobile terminal device 1 and the communication device 2 as the information processing device M described above are merely examples, and the distance measuring system S can be achieved as long as there are at least two information processing devices M capable of transmitting and receiving wireless radio waves, without limiting to the mobile terminal device 1.

For example, in the above-described example, the configuration in which the communication device 2 detects the arrival angle D, corrects the arrival angle D, calculates the distance measurement information, and corrects the distance measurement information has been described. However, some or all of these processes may be executed by the mobile terminal device 1.

Furthermore, the distance measuring system S may include another information processing device M (for example, a server device) that performs various types of processing, in addition to the two information processing devices M that transmit and receive radio waves. For example, the another information processing device M may be configured to execute at least some of the detection of the arrival angle D, the correction of the arrival angle D, the calculation of the distance measurement information, and the correction of the distance measurement information. Furthermore, the above-described table data used for various types of processing may be stored in any information processing device M.

### 5. Summary

As described in each of the examples described above, the communication device 2 as the information processing device M includes the correction processing unit F3 that performs correction related to distance measurement information calculated on the basis of a propagation time of a radio wave from a transmission device (mobile terminal device 1) to the antenna An2 (An2a, An2b) on the basis of information regarding the arrival angle D of a radio wave transmitted from the transmission device and received by the antenna An2.

The correction related to the distance measurement information may be correction of the distance measurement information or correction of the propagation time (phase) to be used for calculation of the distance measurement information.

The propagation time is calculated as a difference between a transmission time and a reception time, and includes not only a spatial propagation time but also an antenna propagation time which is a time during which a signal propagates in the antenna An2.

By setting the propagation time not including the antenna propagation time, that is, by setting the propagation time to include only the spatial propagation time, the distance measurement information about a distance to the transmission device can be appropriately calculated. However, since the antenna propagation time includes an error due to a change in the propagation characteristic of the antenna An2 according to the arrival angle D of the radio wave, the propagation time obtained by uniquely determining the antenna propagation time includes the error.

According to this configuration, by using the information about the arrival angle D, the propagation time is corrected or the distance measurement information is corrected by using the antenna propagation time based on the arrival angle D.

Therefore, appropriate correction according to the propagation characteristic of the antenna An2 can be performed, and the distance measurement accuracy can be improved.

As described with reference to FIGS. 5, 6, and the like, the correction processing unit F3 of the communication device 2 as the information processing device M may perform correction related to the distance measurement information on the basis of the propagation characteristic of the antenna An2 (An2a, An2b).

The propagation characteristic of the antenna An2 indicates a change in the antenna propagation time when the arrival angle D of the radio wave is changed, that is, a change in the antenna phase characteristic. Therefore, by specifying the change in the antenna propagation time on the basis of the arrival angle D of the radio wave and using the change in the antenna propagation time for correction of the propagation time, more accurate distance measurement information can be obtained.

As described with reference to FIG. 7 and the like, the communication device 2 as the information processing device M may include the storage unit 19 that stores the table information (table data) of the propagation characteristic (phase characteristic) of the antenna An2, and the correction processing unit F3 may perform correction related to the distance measurement information by using the table information. By storing the information about the propagation characteristic of the antenna An2 (An2a, An2b) as the table information, it is possible to reduce a storage capacity and simplify the processing.

As described with reference to FIGS. 10, 11, 12, 13, and the like, the correction processing unit F3 of the communication device 2 as the information processing device M may correct the arrival angle D and perform correction related to the distance measurement information by using the corrected arrival angle D.

The accuracy of the calculation result of the arrival angle D of the radio wave varies depending on the propagation characteristic of the antenna An2 (An2a, An2b). Therefore, by obtaining the accurate arrival angle D by the correction, the distance measurement information can be corrected with high accuracy.

As described with reference to FIG. 12 and the like, the correction processing unit F3 of the communication device 2 as the information processing device M may correct the arrival angle D on the basis of a relationship between a calculated value (vertical axis in FIG. 12) and a correct answer value (horizontal axis in FIG. 12) of the arrival angle D.

As a result, the calculated arrival angle D can be corrected to the correct answer value.

As described with reference to FIG. 12 and the like, the communication device 2 as the information processing device M may include the storage unit 19 that stores the table information (table data) of a calculated value and a correct answer value, and the correction processing unit F3 may correct the arrival angle D by using the table information.

By storing the table information about the arrival angle D, it is possible to reduce an amount of information stored in the storage unit 19 and simplify the processing.

As described with reference to FIG. 4 and the like, the communication device 2 as the information processing device M may include the determination processing unit F4 that determines whether or not to correct the arrival angle D.

By determining whether to correct the arrival angle D, an execution frequency of the correction processing of the arrival angle D can be reduced, and a processing load can be reduced.

As described with reference to FIG. 4 and the like, the antenna An2 of the communication device 2 as the information processing device M may be a plurality of antennas An2a and An2b, and the determination processing unit F4 may perform the determination on the basis of the correlation coefficient c indicating a correlation between the individual propagation characteristics (phase characteristics) of the plurality of antennas An2a and An2b.

For example, in a case where the correlation between the propagation characteristics of the two antennas An2a and An2b is high, the antenna propagation time can be canceled only by calculating a difference between the propagation times (a time including the spatial propagation time and the antenna propagation time) of a radio wave for each of the two antennas An2a and An2b, and only a difference between the spatial propagation times is calculated. Therefore, it is possible to calculate the accurate arrival angle D without performing the correction using the table information about the arrival angle D described above.

Whereas, in a case where the correlation between the propagation characteristics of the two antennas An2a and An2b is low, the antenna propagation time cannot be canceled and the accurate arrival angle D cannot be calculated only by calculating the difference between the propagation times of a radio wave for each of the two antennas An2a and An2b. Therefore, the accurate arrival angle D can be calculated by performing correction using the table information about the arrival angle D described above.

As described above, by performing appropriate processing according to a situation, the accurate arrival angle D can be calculated, and the distance measurement information can be appropriately corrected.

Furthermore, in a case where the arrival angle D is not corrected, a processing load of the correction processing unit F3 can be reduced.

As described with reference to FIG. 13 and the like, the determination processing unit F4 of the communication device 2 as the information processing device M may determine not to correct the arrival angle D in a case where the correlation coefficient c is equal to or greater than a threshold value.

In a case where the correlation coefficient c of the propagation characteristic of the antenna An2 (An2a, An2b) is equal to or greater than the threshold value, it is possible to calculate the arrival angle D appropriately to some extent, and thus, it is possible to reduce a processing load of the correction processing unit F3 by omitting the correction.

Note that the correlation coefficient c indicating a correlation between propagation characteristics of the antennas An2 may be calculated in advance and stored in the storage unit 19 of the communication device 2 as the information processing device M. That is, the determination processing unit F4 may acquire a value of the correlation coefficient c from the storage unit 19, and determine whether or not to correct the arrival angle D in accordance with the value.

As described with reference to FIGS. 11, 13, and the like, the communication device 2 as the information processing device M may include the reliability calculation unit F5 that calculates the reliability R of the distance measurement information.

As a result, in an information processing device at a subsequent stage that handles the corrected distance measurement information calculated using the propagation time in consideration of the antenna propagation time, the distance measurement information can be appropriately handled.

As described with reference to FIGS. 11, 13, and the like, the reliability calculation unit F5 of the communication device 2 as the information processing device M may calculate the reliability R in accordance with whether or not the arrival angle D is corrected.

In a case where the accurate arrival angle D can be calculated without performing correction, correction related to the distance measurement information can be appropriately performed, and highly accurate distance measurement information can be obtained. Therefore, by handling the distance measurement information in such a case as distance measurement information with high reliability, it is possible to appropriately handle the distance measurement information in an information processing device or the like in a subsequent stage.

As described with reference to FIG. 4 and the like, the determination processing unit F4 of the communication device 2 as the information processing device M may determine whether or not to correct the arrival angle D in accordance with information indicating mounting modes of a plurality of antennas An2 (An2a, An2b).

For the propagation characteristic of every antenna An2, a level of correlation is determined in accordance with the mounting modes of the antennas An2. Therefore, by determining whether or not to correct the arrival angle D in accordance with the mounting modes of the antennas An2, whether or not to correct the arrival angle D can be determined in accordance with the level of correlation between individual propagation characteristics of the antennas An2.

As described with reference to FIG. 4 and the like, the determination processing unit F4 of the communication device 2 as the information processing device M may determine not to correct the arrival angle D in a case where types and lengths of a plurality of antennas An2 (An2a, An2b) are the same.

As one of the mounting modes, there is a type and a length of the mounted antenna An2 (An2a, An2b). In a case where these modes are the same, it may be determined that the correlation coefficient c is high and it may be determined not to correct the arrival angle D. As a result, a processing load of the correction processing unit F3 can be reduced.

As described with reference to FIGS. 14, 15, and the like, the antenna An2 (An2a, An2b, . . . An2n) of the communication device 2 as the information processing device M may be three or more antennas An2, and the correction processing unit F3 may perform correction related to the distance measurement information by using two antennas An2 having a high correlation coefficient c among the three or more antennas An2.

In a case where the communication device 2 as the information processing device M includes three or more antennas An2, a plurality of combinations of the antennas An2 is conceivable. By calculating and measuring the arrival angle D by using a combination having the high correlation coefficient c among the plurality of combinations, it is possible to obtain highly accurate distance measurement information.

As described with reference to FIG. 4 and the like, the antenna An2 of the communication device 2 as the information processing device M may be a plurality of antennas An2a, An2b, . . . , and the arrival angle D may be calculated on the basis of reception of radio waves by the plurality of antennas An2a, An2b . . . .

The arrival angle D of the radio wave can be calculated by detecting a propagation time (or a phase characteristic of the propagation path) of a radio wave received by each of the plurality of antennas An2a, An2b . . . . Therefore, it is possible to perform appropriate correction according to the arrival angle D of the radio wave and the propagation characteristic of the antenna An2, and to improve the distance measurement accuracy.

As illustrated in FIG. 1 and the like, the communication device 2 as the information processing device M may include a plurality of antennas An2a, An2b . . . .

That is, the above-described effect can be obtained in the communication device 2 as the information processing device M including the antenna An2.

As described with reference to FIG. 16 and the like, the antennas An2a and An2b, . . . of the communication device 2 as the information processing device M may be four or more antennas, and a direction in which a first antenna pair (antennas An2a and An2b) including two of the four antennas are arranged and a direction in which a second antenna pair (antennas An2c and An2d) including another two of the four antennas are arranged may be directions orthogonal to each other.

The first antenna pair is arranged, for example, along the y direction in the xyz space. Furthermore, the second antenna pair is arranged along the x direction in the xyz space, for example.

As a result, for example, a direction in which the arrival angle D can be detected with the first antenna pair and a direction in which the arrival angle D can be detected with the second antenna pair can be made orthogonal to each other.

Therefore, it is possible to increase a range in which the arrival angle D can be detected.

In an information processing method of the present technology, an arithmetic processing device executes processing of performing correction related to distance measurement information calculated on the basis of a propagation time of a radio wave from a transmission device (for example, the mobile terminal device 1) to the antenna An2 (An2a, An2b) on the basis of information regarding the arrival angle D of a radio wave transmitted from the transmission device and received by the antenna An2.

The above-described various functions and effects can be obtained by such an information processing method.

As described in each of the examples described above, a program may be considered, for example, for causing a CPU, a digital signal processor (DSP), or the like, or a device including the CPU, the DSP, or the like, to execute the processing executed by the communication device 2 described in FIGS. 8, 13, 15 and the like.

With such a program, the above-described function as the correction processing unit F3 can be achieved in a device (the mobile terminal device 1 or the communication device 2) as the information processing device M.

The program described above can be recorded in advance in an HDD as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as what is called package software.

Furthermore, such a program can be installed from the removable recording medium into a personal computer or the like, or can be downloaded from a download site via a network such as a LAN or the Internet.

Furthermore, such a program is suitable for widely providing the correction processing unit F3 of the embodiment. For example, by downloading the program to a personal computer, a portable information processing device, a mobile phone, a game device, a video device, a personal digital assistant (PDA), or the like, the personal computer or the like can be caused to function as a device that achieves processing as the correction processing unit F3 of the present disclosure.

Note that the effects described in the present specification are merely examples and are not limited, and other effects may be provided.

Furthermore, the above-described examples may be combined in any way, and the above-described various functions and effects may be obtained even in a case where various combinations are used.

### 6. Present Technology

The present technology can adopt the following configurations.

(1)

An information processing device including:
a correction processing unit configured to perform correction related to distance measurement information calculated on the basis of a propagation time of a radio wave from a transmission device to an antenna, on the basis of information regarding an arrival angle of a radio wave transmitted from the transmission device and received by the antenna.
   (2)

The information processing device according to (1) described above, in which
the correction processing unit performs correction related to the distance measurement information on the basis of a propagation characteristic of the antenna.
   (3)

The information processing device according to (2) described above, further including:
a storage unit configured to store table information about the propagation characteristic, in which
the correction processing unit performs correction related to the distance measurement information by using the table information.
   (4)

The information processing device according to any one of (1) to (3) described above, in which
the correction processing unit corrects the arrival angle, and performs correction related to the distance measurement information by using the corrected arrival angle.
   (5)

The information processing device according to (4) described above, in which
the correction processing unit corrects the arrival angle on the basis of a relationship between a calculated value and a correct answer value of the arrival angle.
   (6)

The information processing device according to (5) described above, further including:
a storage unit configured to store table information about the calculated value and the correct answer value, in which
the correction processing unit corrects the arrival angle by using the table information.
   (7)

The information processing device according to any one of (4) to (6) described above, further including:
a determination processing unit configured to perform determination as to whether or not to correct the arrival angle.
   (8)

The information processing device according to (7) described above, in which
the antenna includes a plurality of antennas, and
the determination processing unit performs the determination on the basis of a correlation coefficient indicating a correlation between individual propagation characteristics of the plurality of antennas.
   (9)

The information processing device according to (8) described above, in which
the determination processing unit determines not to correct the arrival angle in a case where the correlation coefficient is equal to or greater than a threshold value.
   (10)

The information processing device according to any one of (7) to (9) described above, further including:
a reliability calculation unit configured to calculate a reliability of the distance measurement information.
   (11)

The information processing device according to (10) described above, in which
the reliability calculation unit calculates the reliability in accordance with whether or not the arrival angle is corrected.
   (12)

The information processing device according to any one of (8) to (9) described above, in which
the determination processing unit performs the determination in accordance with information indicating a mounting mode of the plurality of antennas.
   (13)

The information processing device according to (12) described above, in which
the determination processing unit determines not to correct the arrival angle in a case where types and lengths of the plurality of antennas are same.
   (14)

The information processing device according to any one of (8) to (9) described above, in which
the antennas are three or more antennas, and
the correction processing unit performs correction related to the distance measurement information by using two antennas in which the correlation coefficient is high among the three or more antennas.
   (15)

The information processing device according to any one of (1) to (14) described above, in which
the antenna includes a plurality of antennas, and
the arrival angle is calculated on the basis of reception of radio waves by the plurality of antennas.
   (16)

The information processing device according to (15) described above, further including:
the plurality of antennas.
   (17)

The information processing device according to any one of (15) to (16) described above, in which
the antennas are four or more antennas, and
a direction in which a first antenna pair including two of the four antennas are arranged and a direction in which a second antenna pair including another two of the four antennas are arranged are orthogonal to each other.
   (18)

An information processing method including:
causing an arithmetic processing device to execute processing of performing correction related to distance measurement information calculated on the basis of a propagation time of a radio wave from a transmission device to an antenna, on the basis of information regarding an arrival angle of a radio wave transmitted from the transmission device and received by the antenna.

### REFERENCE SIGNS LIST

1 Mobile terminal device (transmission device)
19 Storage unit
An2, An2a, An2b Antenna
D Arrival angle
F3 Correction processing unit
F4 Determination processing unit
F5 Reliability calculation unit
C Correlation coefficient
R Reliability

1. An information processing device comprising:
a correction processing unit configured to perform correction related to distance measurement information calculated on a basis of a propagation time of a radio wave from a transmission device to an antenna, on a basis of information regarding an arrival angle of a radio wave transmitted from the transmission device and received by the antenna.

2. The information processing device according to claim 1, wherein
the correction processing unit performs correction related to the distance measurement information on a basis of a propagation characteristic of the antenna.

3. The information processing device according to claim 2, further comprising:
a storage unit configured to store table information about the propagation characteristic, wherein
the correction processing unit performs correction related to the distance measurement information by using the table information.

4. The information processing device according to claim 1, wherein
the correction processing unit corrects the arrival angle, and performs correction related to the distance measurement information by using the corrected arrival angle.

5. The information processing device according to claim 4, wherein
the correction processing unit corrects the arrival angle on a basis of a relationship between a calculated value and a correct answer value of the arrival angle.

6. The information processing device according to claim 5, further comprising:
a storage unit configured to store table information about the calculated value and the correct answer value, wherein
the correction processing unit corrects the arrival angle by using the table information.

7. The information processing device according to claim 4, further comprising:
a determination processing unit configured to perform determination as to whether or not to correct the arrival angle.

8. The information processing device according to claim 7, wherein
the antenna includes a plurality of antennas, and
the determination processing unit performs the determination on a basis of a correlation coefficient indicating a correlation between individual propagation characteristics of the plurality of antennas.

9. The information processing device according to claim 8, wherein
the determination processing unit determines not to correct the arrival angle in a case where the correlation coefficient is equal to or greater than a threshold value.

10. The information processing device according to claim 7, further comprising:
a reliability calculation unit configured to calculate a reliability of the distance measurement information.

11. The information processing device according to claim 10, wherein
the reliability calculation unit calculates the reliability in accordance with whether or not the arrival angle is corrected.

12. The information processing device according to claim 8, wherein
the determination processing unit performs the determination in accordance with information indicating a mounting mode of the plurality of antennas.

13. The information processing device according to claim 12, wherein
the determination processing unit determines not to correct the arrival angle in a case where types and lengths of the plurality of antennas are same.

14. The information processing device according to claim 8, wherein
the antennas are three or more antennas, and
the correction processing unit performs correction related to the distance measurement information by using two antennas in which the correlation coefficient is high among the three or more antennas.

15. The information processing device according to claim 1, wherein
the antenna includes a plurality of antennas, and
the arrival angle is calculated on a basis of reception of radio waves by the plurality of antennas.

16. The information processing device according to claim 15, further comprising:
the plurality of antennas.

17. The information processing device according to claim 15, wherein
the antennas are four or more antennas, and
a direction in which a first antenna pair including two of the four antennas are arranged and a direction in which a second antenna pair including another two of the four antennas are arranged are orthogonal to each other.

18. An information processing method comprising:
causing an arithmetic processing device to execute processing of performing correction related to distance measurement information calculated on a basis of a propagation time of a radio wave from a transmission device to an antenna, on a basis of information regarding an arrival angle of a radio wave transmitted from the transmission device and received by the antenna.
